(19) United States
(12) Patent Application Publication
(10) Pub. No.: US 2012/0304283 A1
(43) Pub. Date: Nov. 29, 2012

(54) BROKERED ITEM ACCESS FOR ISOLATED APPLICATIONS

(75) Inventors: Tyler K. Beam, Redmond, WA (US); Kavitha Radhakrishnan, Redmond, WA (US); Benjamin J. Karas, Seattle, WA (US); Katrina M. Blanch, Seattle, WA (US); Lyon Wong, Issaquah, WA (US); Allen T. Kim, Seattle, WA (US); Steven J. Ball, Seattle, WA (US); J. Tracy Lauricella, Lakewood, WA (US); Scott B. Graham, Seattle, WA (US); Manav Mishra, Kirkland, WA (US)

(73) Assignee: Microsoft Corporation, Redmond, WA (US)

(21) Appl. No.: 13/118,158

(22) Filed: May 27, 2011

(51) Int. Cl. G06F 21/00

(52) U.S. Cl. 726/17

(57) ABSTRACT

A broker module of a computing device receives requests from an isolated application to access one or more items of an item source. In response to a request, storage item objects representing items of the item source are generated and returned to the isolated application for each item of the item source that the isolated application is authorized to access. Whether the isolated application is authorized to access a particular item can be based on particular item sources and/or particular item locations.

### BACKGROUND

Users have access to a wide range of applications from a wide variety of different sources. For example, users traditionally obtained an application from a “bricks and mortar” store on a computer-readable storage medium (such as an optical disc) and then installed the application on the user's home computing device. These applications were generally provided by reputable developers and thus were considered trustworthy.

Subsequent techniques were then developed in which the user accessed a network to locate and install an application. For example, an application marketplace may be made available for access via the Internet to locate and purchase applications. In some instances, the application marketplace may include a multitude of applications, which may originate from a variety of different developers. Because of the sheer number of applications that may be made available and the variances in the developers that may provide them, however, the functionality of the applications may have varying degrees of trustworthiness. For example, the applications may have flawed functionality, may have been written by malicious parties, and so on.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a request is received at a broker module of a computing device. The received request is a request from an isolated application in the computing device to access one or more items of an item source. A check is made as to which (if any) of the one or more items of the item source the isolated application is authorized to access. One or more storage item objects that represent those of the one or more items that the isolated application is authorized to access are generated and the generated storage item objects are returned to the isolated application. However, if the isolated application is authorized to access none of the one or more items, then the received request is denied.

In accordance with one or more aspects, an application invokes an application programming interface (API) of a broker module to request access to one or more items of an item source. The application is an isolated application that is restricted from accessing the item source other than through the broker module. At least one storage item object is received from the broker module, each storage item object containing those of the one or more items that the isolated application is authorized to access.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an example system implementing the brokered item access for isolated applications techniques discussed herein.

FIG. 2 illustrates another example system implementing the brokered item access for isolated applications techniques discussed herein.

FIG. 3 illustrates a data flow of the brokered item access for isolated applications in additional detail in accordance with one or more embodiments.

FIG. 4 illustrates a procedure for implementing the brokered item access for isolated applications in accordance with one or more embodiments.

FIG. 5 illustrates a procedure for implementing the brokered item access for isolated applications in accordance with one or more embodiments.

### DETAILED DESCRIPTION

### Overview

Brokered item access for isolated applications is discussed herein. A broker module is situated between an isolated application and one or more item sources (e.g., a file system, a device, another application). To access items from an item source, the isolated application requests access to an item by invoking an application programming interface (API) of the broker module. If the isolated application is permitted to access the requested item, then the broker module accesses the requested item and returns to the isolated application an object that is a representation of the requested item. If the isolated application is not permitted to access the requested item, then the broker denies the access to the requested item and does not return to the isolated application an object that is a representation of the requested item. The broker module and API are discussed in additional detail below.

In the following discussion, an example system is first described that is operable to perform techniques described herein. Example procedures are then described, which are operable in the example system as well as in other systems. Likewise, the example system is not limited to performance of the example procedures.

Example System

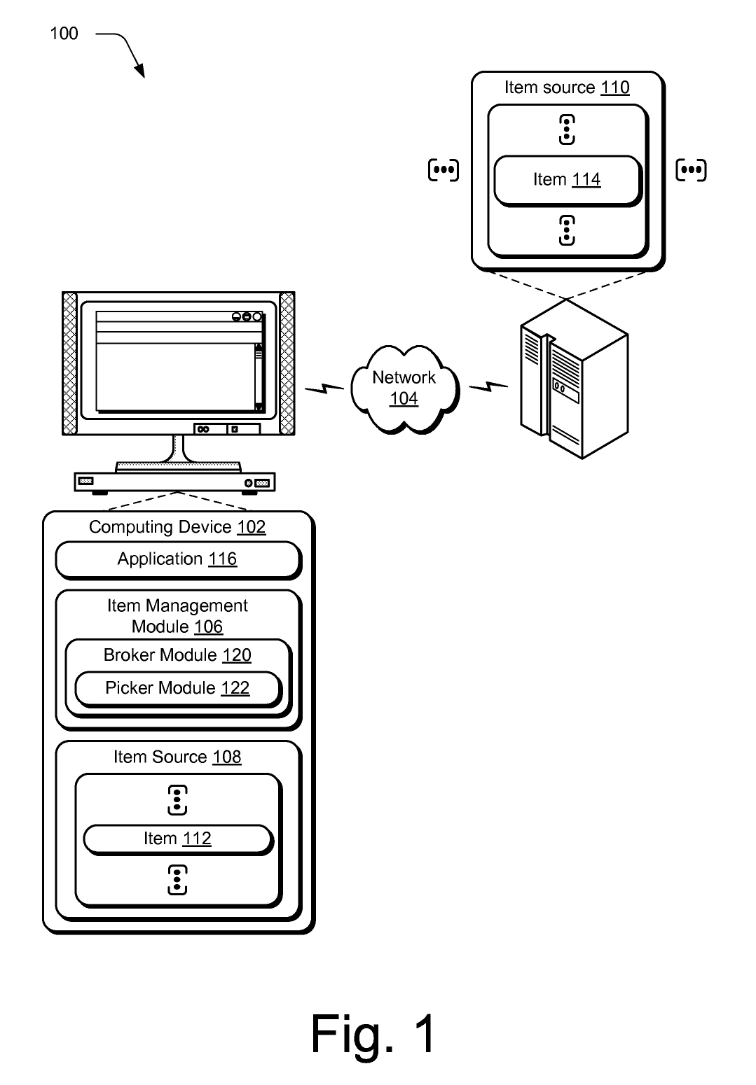

FIG. 1 illustrates an example system 100 implementing the brokered item access for isolated applications techniques discussed herein. The illustrated system 100 includes a computing device 102, which can be configured in a variety of ways. For example, computing device 102 can be configured as a computer that is capable of communicating over a network 104, such as a desktop computer, a tablet or notepad computer, a mobile station, an entertainment appliance, a set-top box communicatively coupled to a display device, a television or other display device, a cellular or other wireless phone, a game console, and so forth.

Computing device 102 may range from a full resource device with substantial memory and processor resources (e.g., personal computers, game consoles) to a low-resource device with limited memory and/or processing resources (e.g., traditional set-top boxes, hand-held game consoles). Additionally, although a single computing device 102 is shown, computing device 102 may be representative of multiple different devices, such as multiple servers utilized by a business to perform operations, a remote control and set-top box combination, an image capture device (e.g., camera) and a game console configured to capture gestures, and so on.

Computing device 102 can also include an entity (e.g., software) that causes hardware of computing device 102 to perform operations, e.g., configures processors, functional blocks, and so on. For example, computing device 102 may include a computer-readable medium that may be configured to maintain instructions that cause the computing device, and more particularly hardware of computing device 102, to perform operations. Thus, the instructions function to configure the hardware to perform the operations and in this way result in transformation of the hardware to perform the operations. The instructions may be provided by the computer-readable medium to computing device 102 through a variety of different configurations.

One such configuration of a computer-readable medium is signal bearing medium and thus is configured to transmit the instructions (e.g., as a carrier wave) to the hardware of computing device 102, such as via network 104. The computer-readable medium may also be configured as a computer-readable storage medium and thus is not a signal bearing medium. Examples of a computer-readable storage medium include a random-access memory (RAM), read-only memory (ROM), optical discs (e.g., DVD or CD), flash memory, hard disk memory, and other memory devices that may use magnetic, optical, and other techniques to store instructions and other data.

Network 104 can assume a variety of different configurations. For example, network 104 can include the Internet, a wide area network (WAN), a local area network (LAN), a personal area network (PAN), a wireless network, a public telephone network, an intranet, combinations thereof, and so on. Further, although a single network 104 is shown, the network 104 may be configured to include multiple networks.

Computing device 102 is illustrated as including an item management module 106. Item management module 106 is representative of functionality to manage access to one or more item sources 108 and/or 110. Item management module 106 can be implemented in a variety of ways, such as a stand-alone application, as part of an operating system of computing device 102, and so on.

Item source 108 employs techniques to organize and store a variety of different types of items 112. An item refers to data or content that can be requested by an application. For example, an item can be a file, a folder or directory, a uniform resource identifier (URI), a uniform resource locator (URL) or other link, compressed files or collections of files (e.g., zip files or cabinet files), a file maintained by (or content maintained in a different manner by) another application, and so forth. Item source 108 can be implemented in a variety of different ways, employing various techniques to organize and store items. For example, item source 108 can be a file system on computing device 102, a storage system on computing device 102, another application running on computing device 102 (e.g., that itself manages organization and storage of items), databases, and so forth. Similarly, item source 110 can be implemented in a variety of different ways, employing various techniques to organize and store items 114 that can be accessed by computing device 102 over network 104. Item source 110 can be, for example, a service provider (e.g., implemented using one or more computing devices configured in the same and/or different ways as computing device 102), a file system of a service provider, a storage system of a service provider, another application running on a service provider, media server, and so forth.

An application 116 is one or more programs, scripts, or other collections of instructions that run on computing device 102. Application 116 can assume a variety of different configurations, such as an entertainment application (e.g., a game or audio/video player), a utility application (e.g., a word processor or Web browser), a reference application (e.g., a dictionary or encyclopedia), and so forth. Application 116 is referred to as an isolated application due to application 116 being executed in a manner in which the ability of application 116 to access resources (e.g., networked computer, the Internet, modules, devices, memory, other applications) of computing device 102 is restricted. The operating system (and/or other software, firmware, and/or hardware) of computing device 102 allows application 116 to access memory and other resources of computing device 102 that have been allocated or otherwise made available to application 116, but prevents application 116 from accessing other memory of, resources of, and/or applications running on computing device 102. This protects other applications running on the computing device from being interfered with by application 116, as well as protects application 116 from being interfered with by other applications running on computing device 102, thus isolating application 116 from other applications on computing device 102. As part of the isolation, the operating system (and/or other software, firmware, and/or hardware) of computing device 102 also prevents application 116 from accessing item source 108 and/or item source 110, except through item management module 106 as discussed in more detail below.

In one or more embodiments, application 116 is executed in a restricted manner by executing application 116 in a sandbox. Although a single application 116 is illustrated in computing device 102, it should be noted that multiple applications can be executing in computing device 102 concurrently (each application being executed in its own sandbox).

Item management module 106 is further illustrated as including a broker module 120 and a picker module 122. Broker module 120 is representative of functionality of item management module 106 to manage access of application 116 to item source 108 and/or 110. Broker module 120, for instance, can act as an intermediary to locate items 112 and/or 114 requested by application 116 and provide the located items 112 and/or 114 back to application 116. Application 116 can access items 112 and/or 114 through broker module 120, but due to it being an isolated application is otherwise restricted from accessing item source 108 and/or 110 (as well as items 112 and/or 114 within these item sources). Further, the items 112 and/or 114 can be provided to application 116 and application 116 need not be aware of where the items 112 and/or 114 were obtained, e.g., application 116 can be unaware of the namespace used by item source 108 and/or 110. This allows an application to treat items from various item sources in a uniform manner and not specific to each kind of item source.

Additionally, broker module 120 may optionally employ picker module 122 to provide an alternative way to gain access to item source 108 and/or 110. Picker module 122 provides a trusted method to allow an application (e.g., which does not have programmatic access to item source 108 and/or 110 via broker module 120) to access item source 108 and/or 110 (as well as items 112 and/or 114 within these item sources).

Generally, any of the functions described herein can be implemented using software, firmware, hardware (e.g., fixed logic circuitry), manual processing, or a combination of these implementations. The terms “module” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks.

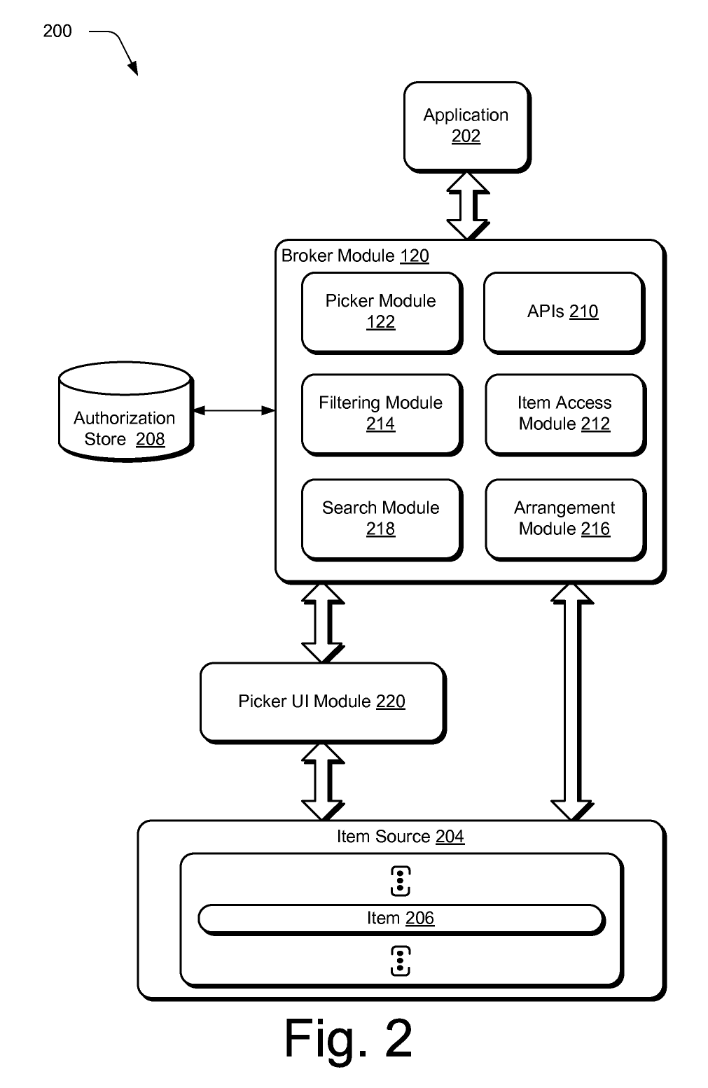

FIG. 2 illustrates an example system 200 implementing the brokered item access for isolated applications techniques discussed herein. System 200 as illustrated may be implemented in part by the item management module 106 of computing device 102 of FIG. 1 to perform item management techniques. For example, item management module 106 can be incorporated as part of an operating system, an application that executes in conjunction with the operating system, a stand-alone application, and so on. Regardless of where incorporated, item management module 106 can employ techniques to manage items accessible to the computing device locally and/or remotely (e.g., via network 104 of FIG. 1).

System 200 as illustrated includes an application 202 (which can be, for example, an application 116 of FIG. 1), an item source 204 (which can be, for example, an item source 108 or 110 of FIG. 1), and an item 206 (which can be, for example, an item 112 or 114 of FIG. 1). In this example, application 202 communicates with broker module 120 via one or more application programming interfaces (APIs) 210 exposed to application 202 by broker module 120 to access item source 204. Although a single application 202 and a single item source 204 are illustrated in FIG. 2, it should be noted that system 200 can include any number of applications 202 accessing any number of item sources 204.

Application 202 can be authorized to access particular item sources and/or particular item locations. This authorization can be performed at different times and in different ways, although is typically performed previous to application 202 requesting access to item 206. In one or more embodiments, this authorization is performed when application 202 is downloaded to or installed on the computing device implementing system 200. For example, as part of the download or installation process, the user can be notified of particular item sources and/or particular item locations that application 202 desires to access, and the user can provide input (e.g., selection of a particular button or other part of a user interface (UI)) as to whether application 202 is authorized to access those particular item sources and/or particular item locations. Alternatively, this authorization can be performed at other times, such as when application 202 is modified or updated, during subsequent configuration of application 202 by a user of system 200, and so forth. Regardless of how performed, system 200 maintains an authorization store 208 that includes a record of which item sources and/or item locations application 202 is authorized to access. Authorization store 208 is accessible to broker module 120, allowing the record of which item sources and/or item locations application 202 is authorized to access to be obtained and used by broker module 120.

Application 202 can be authorized to access any of a variety of different item sources 204 supported by broker module 120. For example, item sources that an application 202 can be authorized to access can be a file system, one or more particular applications running on a computing device, one or more particular storage systems implemented by a service provider, and so forth.

Application 202 can also be authorized to access any of a variety of different item locations. Different types of item locations can be defined for different item sources. For example, for an item source that is a file system, the item locations can be defined as folders or libraries (e.g., a documents library, a music library, a video library, a picture library). A library refers to a collection of one or more locations (e.g., folders or directories on one or more devices), and the locations included in a library can optionally be modified by a user of system 200. By way of another example, for an item source that is an application, the item locations can be groupings or other collections of items as defined by the application.

Broker module 120 includes an item access module 212, which is representative of functionality of broker module 120 to respond to requests from application 202 to access items. APIs 210 support various interfaces that can be invoked by application 202 for various different types of access to items. For example, APIs 210 include interfaces permitting reading items, writing items, creating items, deleting items, modifying items, copying items, moving items, renaming items, retrieving properties of items, and so forth. The same interfaces can be used for different item sources, abstracting the item sources from application 202. For example, APIs invoked to retrieve or enumerate items can be applied to multiple item sources supported by broker module 120, to item sources supported by broker module 120 that application 202 is authorized to access, and so forth. By way of another example, application 202 need not specify an item source when invoking an API to write or rename an item (e.g., the item source can be identified in or inherent in the storage item object as discussed in more detail below).

Alternatively, a parameter of the interface identifying the particular item source for a request can be included. For example, APIs 210 can include a read item interface used for both a file system source and a service provider storage system source, with a parameter of the read item interface indicating for which of the two sources the application 202 is requesting to read items. In other alternatives, different interfaces can be used for different item sources. For example, APIs 210 can include a file system read item interface used to read items from a file system source, and a service provider read item interface used to read items from a service provider storage system source.

Application 202 invokes one or more APIs 210 requesting access to one or more items of (e.g., stored by) an item source. Upon receiving the request, item access module 212 checks the record of item sources and/or item locations that application 202 is authorized to access, and determines based on this record whether application 202 is authorized to access the requested item or items. If application 202 is not authorized to access any of the requested one or more items (the application is authorized to access none of the one or more items), then item access module 212 does not grant the requested access. For example, if application 202 requests to access a file in a picture library but is authorized to access only files in a music library, then item access module 212 does not grant the requested access. Item access module 212 can optionally return an indication (e.g., as a result value associated with an API 210 invoked by application 202 to request access to the one or more items) that the requested access is denied.

However, if application 202 is authorized to access some of the requested one or more items, then item access module 212 obtains and permits access to those of the one or more items that application 202 is authorized to access. The manner in which the requested one or more items are obtained by broker module 120 can vary based on the particular item source 108, and broker module 120 is configured with (or can obtain) an indication of how to access item source 108. Item access module 212 generates a storage item object representing each item that application 202 is authorized to access. This storage item object includes various information associated with the item, and optionally includes the data and/or content of the item. Item access module 212 returns this generated storage item object to application 202.

Alternatively, rather than using previously received authorization to access an item or items, broker module 120 may employ picker module 122 to obtain access to one or more items that are requested by application 202. Upon receiving the request to access one or more items, broker module 120 can implement picker module 122 to generate a user interface, which launches picker UI module 220. Picker UI module 220 presents a UI querying the user as to whether the user authorizes access to the one or more items, allowing the user to navigate to or otherwise locate the one or more items, and so forth. A user input can be received, indicating whether the user authorizes application 202 to access the one or more items. If the user authorizes application 202 to access the one or more items, then picker module 122 obtains the one or more items and returns the obtained one or more items to item access module 212 for generation of the storage item object representing 112. Alternatively, rather than picker module 122 obtaining the one or more items, picker module 122 can return an indication to item access module 212 for module 212 to obtain the one or more as discussed above.

Item access module 212 returns storage item objects to application 202. A storage item object represents an item. The storage item object is an abstraction or representation of the item. Access by application 202 (e.g., reading, writing, modifying, etc.) to the item represented by the storage item object is performed through broker module 120 and/or the storage item object itself. The storage item object can take various different forms. In one or more embodiments, the storage item object is an object generated by broker module 120 and exposed to application 202. Broker module 120 returns such a storage item object to application 202 by providing an identifier or other indication of the storage item object to application 202. Various methods or operations of the storage item object can be invoked by application 202 to obtain information regarding the item represented by the storage item object and/or perform various operations on the item represented by the storage item object. Alternatively, the storage item object can be a data structure that can include various information regarding the item represented by the storage item object, and/or various methods or operations that can be invoked by application 202 to perform various operations on the storage item object. Broker module 120 returns such a storage item object by providing the data structure to application 202.

In one or more embodiments, the storage item object includes a properties portion, a thumbnail portion, a content portion, and an operations portion. The properties portion of the storage item object includes various properties or attributes of the item. Any of a variety of different properties or attributes maintained by item source 204 for items can be included in the properties portion of the storage item object. For example, the properties portion of the storage item object can include the name of the item, a size (e.g., in bytes) of the item, a type of the item (e.g., picture type, music type, etc.), and so forth.

The thumbnail portion of the storage item object includes a visual representation of the item. This thumbnail can be an image or a sequence of images (e.g., a video). The thumbnail can be, for example, a portion of the item (e.g., one page of a document or part of a picture), a reduced-scale version of the item (e.g., a smaller-scale version of a picture), an icon representing a type of the item, and so forth.

The content portion of the storage item object includes the content of an item or an indication of how to obtain the content of the item. For example, if the item is a picture, then the content portion can include the data of the picture itself, or a link (e.g., Uniform Resource Locator (URL) or path) to where the data of the picture is stored. The item can be data that is streamed to application 202 (e.g., a music file or video file), and the indication of how to obtain the content of the item can include an indication of (e.g., link to) the data to be streamed. The content portion can also include some operations on items, such as operations to read the item and write to the item.

The operations portion of the storage item object includes one or more methods or operations that can be performed on the item. Various different operations can be performed on an item, providing various different access to the item. The particular operations can vary based at least in part on the type of the item. For example, the operations can include operations to rename the item, delete the item, and so forth. For an item that is a folder of a file system, the operations can also include enumerating files in the folder, sorting files in the folder, deleting files in the folder, adding new files to the folder, renaming the folder or a file in the folder, and so forth.

Regardless of the form of the storage item object, various operations can be performed on the storage item object and the storage item object includes the content of an item or an indication of how to obtain the content of the item. Thus, the storage item object can also be viewed as containing one or more items. For example, a storage item object for a folder can contain one or more items representing files within that folder.

Although a storage item object is discussed herein, it should be noted that different types of storage item objects can be supported. Different types of storage item objects can include different properties, operations, and so forth relevant to that type of storage item. For example, storage file objects and storage folder objects can be used. The storage file objects include properties and operations particular to files (e.g., a rename file operation), and the storage folder objects include properties and operations particular to folders (e.g., an enumeration operation to enumerate files in a folder). By way of another example, device objects and network node objects can be used, with the device objects including properties and operations particular to devices, and the network node objects including properties and operations particular to network nodes.

One or more of the storage item objects returned to application 202 can be persisted by application 202. For example, application 202 can use a most recently used (MRU) list, allowing one or more of the items most recently used by application 202 to be readily identified. In one or more embodiments, broker module 120 manages the persisted storage of storage item objects. Broker module 120 typically maintains a persisted access list for each isolated application, although multiple isolated applications can optionally share a persisted access list. A persisted access list is a list of persisted storage item objects, and application 202 can invoke an API 210 to retrieve and use the persisted storage item objects in the persisted access list. Broker module 120 can provide tokens or other identifiers of persisted storage item objects to application 202 when a persisted storage item is added to the persisted access list, and application 202 can use such tokens or other identifiers to subsequently retrieve a persisted storage item object from the persisted access list. Broker module 120 can also maintain multiple lists of persisted storage item objects for application 202, such as an MRU list and a separate persisted access list (e.g., allowing application 202 to persist storage item objects as it desires independently of how recently the items were used). Broker module 120 can optionally implement different lifetime rules for the different lists, reflecting different durations (and/or different manners in which durations are determined) for keeping storage item objects on a list.

Persisted storage item objects can be identified in a variety of different manners, such as by device identifier, operating system (e.g., NTFS) object identifier, name/timestamp matches, combinations thereof, and so forth. Thus, persisted storage item objects can be identified even if the item has been renamed or moved. Additionally, storage item objects can be persisted across multiple executions of application 202, allowing application 202 to retrieve and use the persisted storage item object when application is again executed after having been terminated (e.g., having been shut down or deactivated).

Alternatively, application 202 can manage the persisted storage of storage item objects rather than broker module 120. Application 202 can persist the storage item objects rather in different locations, such as being stored in a memory or other storage location allocated or otherwise made available to application 202. Thus, if application 202 desires an item again at a later time, application 202 can use the persisted storage item object representing the item rather than re-requesting the item from broker module 120.

Broker module 120 optionally includes a filtering module 214, which is representative of functionality of broker module 120 to filter items that can be accessed by application 202. Application 202 is authorized to access particular item sources and/or particular item locations as discussed above. Filtering module 214 allows access requests to be further filtered, preventing particular item locations from being accessed by application 202 even if access is otherwise authorized. Filtering module 214 filters items from item source 204 prior to item access module 212 returning generated storage items representing those items. Thus, storage items representing filtered items are not returned to application 202 regardless of the particular item sources and/or particular item locations application 202 is authorized to access.

Filtering module 214 can be configured to filter particular item locations based on, for example, the desires of a designer of broker module 120 and/or an administrator of system 200. For example, filtering module 214 can filter particular folders or directories storing system files, preventing application 202 from accessing those particular folders or directories. By way of another example, filtering module 214 can filter particular files types, such as system files, hidden files, and so forth.

Broker module 120 also optionally includes an arrangement module 216, which is representative of functionality of broker module 120 to arrange items in a particular order and/or particular grouping. Application 202 can request that items be returned by broker module 120 arranged in a particular order and/or grouping. Arrangement module 216 arranges the items in the requested order at different times, such as sorting and/or grouping the accessed items prior to item access module 212 generating the storage item objects representing the requested items, sorting and/or grouping the storage item objects representing the requested items that are generated by item access module 212, and so forth.

A variety of different orderings can be supported by arrangement module 216, and different orderings based on different sort criteria can be supported for different item types or item locations. For example, items can be ordered (e.g., chronologically increasing or decreasing) based on an associated date (e.g., date a picture was taken for picture items, date an item was stored in item source 204, date a song was recorded for music items). By way of another example, items can be ordered (e.g., alphabetically) based on a recording artist (e.g., for music items or video items), based on an album name (e.g., for music items or video items), based on genre (e.g., for music items or video items), and so forth. Arrangement module 216 can support a set of particular orderings from which application 202 can choose. Alternatively, arrangement module 216 can support sort criteria based on any metadata for items supported by item source 204. Thus, any properties, attributes, or other metadata associated with items can be identified by application 202 as the sort criteria to be used for the ordering.

Similarly, a variety of different groupings can be supported by arrangement module 216, and different groupings based on different grouping criteria can be supported for different item types or item locations. For example, items can be grouped by item type (e.g., music items grouped together and document items grouped together). By way of another example, items can be grouped based on a recording artist (e.g., for music items or video items), based on an album name (e.g., for music items or video items), based on genre (e.g., for music items or video items), and so forth. A grouping can be a set of container storage item objects that each contain one or more storage item objects, and that can be enumerated to provide storage item objects matching a particular condition. Arrangement module 216 can support a set of particular groupings from which application 202 can choose. Alternatively, arrangement module 216 can support grouping criteria based on any metadata for items supported by item source 204. Thus, any properties, attributes, or other metadata associated with items can be identified by application 202 as the grouping criteria to be used for the grouping.

Within a particular grouping, items can be sorted using various sort criteria as discussed above, or alternatively need not be sorted. Furthermore, application 202 can request to search storage item objects of a particular grouping, providing a variety of different search criteria analogous to the discussion below regarding search module 218.

Broker module 120 also optionally includes a search module 218, which is representative of functionality of broker module 120 to search for particular items. Application 202 can request that items satisfying particular search criteria be returned by broker module 120. Search module 218 searches item source 204 for the items satisfying (e.g., matching) the search criteria, and those items satisfying the search criteria are returned to application 202. Search module 218 typically searches items in item source 204 to identify the items that satisfy the search criteria prior to item access module 212 generating the storage item objects representing the requested items that satisfy the search criteria. Alternatively, search module 218 can search the generated storage item objects to identify the storage item objects that satisfy the search criteria, and only the generated storage item objects that satisfy the search criteria are returned to application 202.

A variety of different search criteria can be supported by search module 218. For example, search criteria can be a particular item type (e.g., a music file) and the search criteria are satisfied by any item of that particular item type, or the search criteria can be a name and the search criteria are satisfied by any item having that particular name (e.g., file name). Additionally, more complex search criteria can be supported by search module 218, such as the use of date ranges, wild card values (e.g., a question mark to indicate any single character or an asterisk to indicate any zero or more characters), an AQS or Advanced Query Syntax (additional information regarding the Advanced Query Syntax is available from Microsoft® Corporation of Redmond, Wash.), and so forth. It should also be noted that although application 202 can provide search criteria, application 202 is still able to access only those items that application 202 is authorized to access (e.g., based on the record maintained in authorization store 208 as discussed above).

Additionally, broker module 120 is discussed as permitting application 202 to access the item or items if application 202 is authorized to access the item or items. Broker module 120 can optionally treat application 202 as automatically authorized to access one or more item locations without any specific user input indicating such authorization. An example of such a location is a downloads folder to which all isolated applications are permitted to write data. Broker module 120 can optionally restrict application 202 to specific types of access unless application 202 is authorized (as discussed above) to access those one or more item locations. For example, application 202 can be automatically authorized to write files to a downloads folder, but is permitted to read files from the downloads folder only if the user of the computing device has authorized application 202 to read files from the downloads folder.

The brokered item access for isolated applications techniques discussed herein support various usage scenarios. For example, a photo editing application can be run, accessing files via the broker module. When the photo editing application is installed on the computing device, the user can give the photo editing application authorization to access files in a pictures library, but not files in other locations. During operation, photo editing application can request various files from the broker module, but the broker module denies requests for any files other than files from the pictures library. The photo editing application is thus prohibited from accessing any files stored in any location other than the pictures library.

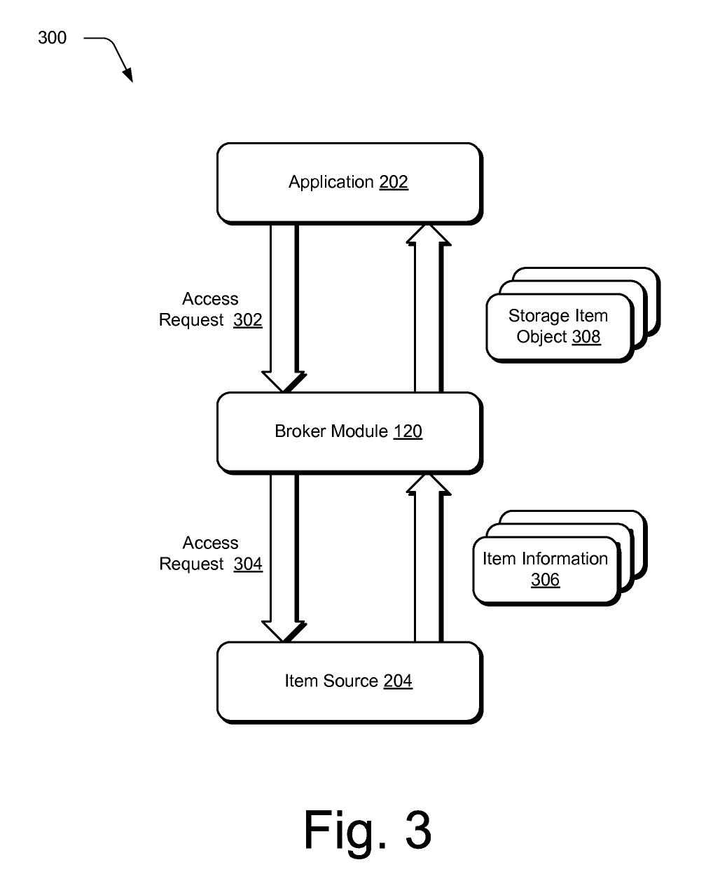

FIG. 3 illustrates a data flow 300 of the brokered item access for isolated applications in additional detail in accordance with one or more embodiments. Data flow 300 is discussed with reference to elements of system 200 of FIG. 2. Application 202 submits an access request 302 to broker module 120 by invoking one or more APIs of broker module 120. Access request 302 is a request for a particular type of access to item source 204.

Broker module 120 submits one or more access requests 304 to item source 204 to obtain the items requested by access request 302. Broker module 120 can submit one or more access requests 304 in various manners depending on the manner in which item source 204 is implemented, such as by invoking an API of item source 204, sending a message or other data structure to item source 204, and so forth.

Item information 306 for one or more items are returned from item source 204 to broker module 120. The item information 306 describes one or more items based on access request 302. As discussed above, the items for which item information 306 is returned can include information for items at particular item sources, can be filtered items, and so forth. Item information 306 includes information describing one or more items from item source 204. Any information that can be included in a storage item object representing an item can be included in item information 306.

Broker module 120 generates one or more storage item objects 308 based on item information 306. Broker module 120 generates a storage item object 308 for at least one item identified in item information 306. Broker module 120 can optionally filter one or more items identified from item information 306 and not generate a storage item object 308 for the filtered one or more items as discussed above. Broker module 120 can also optionally arrange storage item objects 308, or information included in storage item objects 308, into a particular order or particular grouping as discussed above.

Example APIs

The broker module exposes one or more APIs to isolated applications, the one or more APIs supporting various interfaces that can be invoked by the isolated applications for various different types of access to items. For example, broker module 120 exposes APIs 210 as discussed above. Tables I-XI below illustrate example APIs that can be exposed by the broker module. It should be noted that these APIs are examples, and that one or more of the APIs may not be exposed by the broker module, additional APIs may be exposed by the broker module, and/or changes can be made to these APIs exposed by the broker module.

APIs are grouped or collected together into particular namespaces, and each of Tables I-XI includes APIs for a particular namespace. The manner in which such grouping is performed can vary, for example, based on the desires of the developer of the broker module. The names of the APIs have a preamble that identifies the particular namespace, and the names of the APIs listed in Tables I-XI include this common preamble (although it is not listed in the tables). For example, for a known folders namespace, the common preamble can be “Windows.Storage.KnownFolders”. Accordingly, the name for a “musicLibrary” API includes this common preamble, and thus although listed as “musicLibrary” in Table IV below, is “Windows.Storage.KnownFolders.musicLibrary”.

Table I illustrates APIs for a storage item object, which can also be referred to as a storage item namespace. The common preamble for the storage item namespace is “Windows.Storage.StorageItem”. The APIs for the storage item namespace allow isolated applications to obtain information regarding the item represented by the storage item object and/or perform various operations on the item represented by the storage item object.

TABLE I

| Name | Description |
|---|---|
| getThumbnailAsync( ) | Function to get the thumbnail of the item represented by the |
| | current storage item object. |
| renameAsync( ) | Function to change the name of the item represented by the |
| | current storage item object to a name specified by the isolated |
| | application. |
| deleteAsync( ) | Function to delete the item represented by the current storage |
| | item object. |
| isOfType( ) | Function to check whether the current storage item object is a |
| | StorageFile storage item object or StorageFolder storage item |
| | object. |
| name | The name of the item represented by the current storage item |
| | object. |
| size | The size (e.g., in bytes) of the item represented by the current |
| | storage item object. |
| displayType | The item type (e.g., picture, video, document) of the item |
| | represented by the current storage item object, formatted for |
| | consumption by the user. |
| contentType | The item type (e.g., picture, video, document) of the item |
| | represented by the current storage item object. |
| path | A path identifying where the item represented by the current |
| | storage item object is located. |
| attributes | Attributes of the item represented by the current storage item |
| | object maintained by the item source. |
| dateModified | A date that the item represented by the current storage item |
| | object was most recently modified. |
| dateCreated | A date that the item represented by the current storage item |
| | object was created. |
| folderRelativeId | An identifier that can be used to uniquely identify an item |
| | relative to its parent folder. |
| ExtraProperties | Additional “System” properties of the item represented by the |
| | current storage item object that are maintained by the item |
| | source and can be retrieved. |
| getMusicPropertiesAsync( )s | Function to retrieve music-specific properties of an item of a |
| | music item type that are accessible via an asynchronous (async) |
| | call. |
| getVideoPropertiesAsync( ) | Function to retrieve video-specific properties of an item of a |
| | music item type that are accessible via an asynchronous call. |
| getImagePropertiesAsync( ) | Function to retrieve picture- or image-specific properties of an |
| | item of a music item type that are accessible via an asynchronous |
| | call. |
| getDocumentPropertiesAsync( ) | Function to retrieve document-specific properties of an item of a |
| | music item type that are accessible via an asynchronous call. |

Table II illustrates APIs for a storage folder (or StorageFolder) storage item object, which can also be referred to as a storage folder namespace. The common preamble for the storage folder namespace is “Windows.Storage.StorageFolder”. The APIs for the storage folder namespace allow isolated applications to obtain information regarding the folder represented by the storage folder object and/or perform various operations on the folder represented by the storage folder object. A storage folder object inherits or includes all of the APIs of a storage item object discussed above with reference to Table I.

TABLE II

| Name | Description |
|---|---|
| createFileAsync( ) | Creates a file within the current StorageFolder storage item |
| | object. |
| createFolderAsync( ) | Create a folder within the current StorageFolder storage item |
| | object. |
| getIndexedStateAsync( ) | Function to determine if the current StorageFolder storage |
| | item object represents a location which has its items' |
| | properties stored in a database for faster property retrieval. |
| areQueryOptionsSupported(QueryOptions) | Checks, and returns an indication of whether, the passed |
| | query options can be applied to the current StorageFolder |
| | storage item object. |
| isCommonFileQuerySupported(CommonFileQuery) | Checks, and returns an indication of whether, the passed |
| | common file query options (one or more options pre-defined |
| | for application use) can be applied to the current |
| | StorageFolder storage item object. |
| isCommonFolderQuerySupported(CommonFolderQuery) | Checks, and returns an indication of whether, the passed |
| | common folder query options (one or more options pre- |
| | defined for application use) can be applied to the current |
| | StorageFolder storage item object. |
| getFileAsync(name) | Function to perform a single file retrieval. |
| getFolderAsync(name) | Function to perform a single folder retrieval. |
| getItemAsync(name) | Function to perform a single file or folder retrieval. |

Table III illustrates APIs for a storage file (or StorageFile) storage item object, which can also be referred to as a storage file namespace. The common preamble for the storage file namespace is “Windows.Storage.StorageFile”. The APIs for the storage file namespace allow isolated applications to obtain information regarding the file represented by the storage file object and/or perform various operations on the file represented by the storage file object. A storage file object inherits or includes all of the APIs of a storage item object discussed above with reference to Table I.

TABLE III

| Name | Description |
|---|---|
| fileName | The name of the file represented by the current StorageFile |
| | storage item object. |
| fileType | The item type (e.g., picture, video, document) of the file |
| | represented by the current StorageFile storage item object. |
| openAsync | Opens a random access stream for consumption, allowing the |
| | data for the file represented by the current StorageFile storage |
| | item object to be provided to the isolated application for both |
| | read and write. |
| openForReadAsync | Opens an input stream allowing the isolated application to |
| | read data for the file represented by the current StorageFile |
| | storage item object. |
| copyAsync(destinationFolder, | Copy a single file to a new location specified by |
| newFileName, nameCollisionOption) | destinationFolder. The name of the new file can optionally be |
| | specified as newFileName, and collision options (e.g., how to |
| | resolve collisions/duplicates in file names) can optionally be |
| | specified as nameCollisionOption. |
| copyAndReplaceAsync(fileToReplace) | Copy a single file represented by the current StorageFile |
| | storage item object to a specified location, and overwrite the |
| | file at that specified location. |
| moveAsync(destinationFolder, | Move a single file to a new location specified by |
| newFileName, nameCollisionOption) | destinationFolder. The name of the new file can optionally be |
| | specified as newFileName, and collision options (e.g., how to |
| | resolve collisions/duplicates in file names) can optionally be |
| | specified as nameCollisionOption. |
| moveAndReplaceAsync(fileToReplace) | Move a single file represented by the current StorageFile |
| | storage item object to a specified location, and overwrite the |
| | file at that specified location. |

Table IV illustrates APIs for a known folders namespace, which refers to a set of folders or libraries of a file system item source that can be accessed by isolated applications. The common preamble for the known folders namespace is “Windows.Storage.KnownFolders”. The APIs for the known folders namespace allow a particular set of pre-defined folders or directories to be accessed by isolated applications.

TABLE IV

| Name | Description |
|---|---|
| musicLibrary | Returns a storage item object representing a Music |
| | Library folder, including identification of files |
| | stored in the Music Library folder. |
| picturesLibrary | Returns a storage item object representing a Pictures |
| | Library folder, including identification of files |
| | stored in the Pictures Library folder. |
| videosLibrary | Returns a storage item object representing a Videos |
| | Library folder, including identification of files |
| | stored in the Videos Library folder. |
| recordedTVLibrary | Returns a storage item object representing a |
| | Recorded TV Library folder, including |
| | identification of files stored in the Recorded TV |
| | Library folder. |
| documentsLibrary | Returns a storage item object representing a |
| | Documents Library folder, including identification |
| | of files stored in the Documents Library folder. |
| homeGroup | Returns a storage item object representing a |
| | Homegroup folder, including identification of files |
| | stored in the Homegroup folder. |
| removableDevices | Returns a storage item object representing a |
| | Removable Devices folder, including identification |
| | of files stored in the Removable Devices folder. |
| mediaServerDevices | Returns a storage item object representing a Media |
| | Server Devices folder, including identification of |
| | files stored in the Media Server folder. |

Table V illustrates APIs for a storage namespace, which is a set of interfaces allowing isolated applications to store or retrieve particular files or folders. The common preamble for the storage namespace is “Windows.Storage”.

TABLE V

| Name | Description |
|---|---|
| DownloadsFolder | Returns a storage item object representing |
| | a Downloads folder, including |
| | identification of files stored in the |
| | Downloads folder. |
| getFileFromPathAsync(path) | Returns a StorageFile storage item object |
| | from the location specified by the given |
| | path. |
| getFileFromUriAsync(uri) | Returns a StorageFile storage item object |
| | from the location specified by the given |
| | URI. |
| createFileForTransferAsync( ) | Returns a storage item object that is a |
| | Transfer File (a temporary StorageFile |
| | storage item object to which streamed data |
| | can be subsequently written). |
| getFolderFromPathAsync( ) | Returns a StorageFolder storage item |
| | object from the location specified by the |
| | given path |

Table VI illustrates APIs for query options, which can also be referred to as a query options namespace. The common preamble for the query options namespace is “Windows.Storage.QueryOptions”. The APIs for the query options namespace allow isolated applications to specify various query options for search requests submitted by the isolated applications.

TABLE VI

| Name | Description |
|---|---|
| fileTypeFilter | Adds a file extension filter to the query to specify |
| | particular file extension types to be searched for. |
| folderDepth | Specifies whether the query is deep or shallow |
| | (e.g., whether sub-folders are to be searched) |
| applicationSearchFilter | Adds an AQS search filter to the query. |
| userSearchFilter | Adds a second AQS search filter to the query. |
| searchLocale | Specifies the search locale (e.g., item source or |
| | location of an item source) of the query. |
| indexerOption | Specifies whether only locations that are |
| | “indexed” (have their item properties cached in a |
| | database) should be queried. |
| sortOrder | Adds an “OrderBy” sort to the query, specifying |
| | a particular order for arranging the storage item |
| | objects returned by the search. |
| stackPropertyName | Adds a “GroupBy” shape to the query, specifying |
| | a particular grouping for arranging the storage |
| | item objects returned by the search. |
| dateStackOption | For items grouped by date, indicates if the |
| | grouping should be by day, month, year, etc. |
| saveToString( ) | Function to save the query options to a string to |
| | handle tombstoning (e.g., forced suspension of |
| | the isolated application, such as to reduce power |
| | consumption). |
| loadFromString(string) | Function to load the query options from a string |
| | to handle tombstoning (e.g., forced suspension |
| | of the isolated application, such as to reduce |
| | power consumption). |

Table VII illustrates APIs for a query namespace, which is a set of interfaces allowing isolated applications to submit queries or searches for items. The common preamble for the query namespace is “Windows.Storage”.

TABLE VII

| Name | Description |
|---|---|
| StorageQueryResultBase. | Event that is fired when the file item contents behind a |
| contentsChanged | query have changed. |
| StorageQueryResultBase. | Event that is fired when the query options for a query |
| optionsChanged | have been changed. |
| StorageQueryResultBase. | Allows the app to look up the index of the first item |
| findStartIndexAsync( ) | that corresponds to the provided |
| | value of the first sort order property. |
| StorageQueryResultBase. | Function to retrieve the current query options of the |
| getCurrentQueryOptions( ) | current query. |
| StorageQueryResultBase. | Function to apply new query options specified as |
| applyNewQueryOptions(queryOptions) | queryOptions to the current query. |
| StorageQueryResultBase. | Function to get the number of items behind (satisfied |
| getItemCountAsync( ) | by) a query. |
| StorageFileQueryResult. | Function to retrieve files satisfied by a query. |
| getFilesAsync( ) | |
| StorageFileQueryResult. | Function to retrieve from a query a number of files |
| getFilesAsync(start, count) | specified by count and beginning at an index specified |
| | by start. |
| StorageFolderQueryResult. | Function to retrieve folders satisfied by a query. |
| getFoldersAsync( ) | |
| StorageFolderQueryResult. | Function to retrieve from a query a number of folders |
| getFoldersAsync(start, count) | specified by count and beginning at an index specified |
| | by start. |
| StorageItemQueryResult. | Function to retrieve items satisfied by a query |
| getItemsAsync( ) | |
| StorageItemQueryResult. | Function to retrieve from a query a number of items |
| getItemsAsync(start, count) | specified by count and beginning at an index specified |
| | by start. |

Table VIII illustrates APIs for a quick accessors namespace, which is a set of interfaces allowing items to be retrieved (e.g., quickly, without specifying an AQS query). The APIs can support retrieving items in different ways, such as a shallow mode (e.g., returning results from a particular folder or directory), a deep mode (e.g., returning results from a particular folder or directory as well as all sub-folders or sub-directories), and so forth. The common preamble for the quick accessors namespace is “Windows.Storage.StorageFolder”.

TABLE VIII

| Name | Description |
|---|---|
| getFilesAsync( ) | Retrieve files arranged in a by-folder grouping. |
| getFiles(CommonFileQuery) | Retrieve files using the passed common file query |
| | options. |
| getFiles(CommonFileQuery, | Retrieve, using the passed common file query options, |
| start, count) | a number of files specified by count and beginning at |
| | an index specified by start. |
| getFoldersAsync( ) | Retrieve folders arranged in a by-folder grouping. |
| getFoldersAsync(CommonFolderQuery) | Retrieve folders using the passed common folder query |
| | options. |
| getFoldersAsync(CommonFolderQuery, | Retrieve, using the passed common folder query |
| start, count) | options, a number of folders specified by count and |
| | beginning at an index specified by start. |
| getItemsAsync( ) | Retrieve files and folders arranged in a by-folder |
| | grouping. |
| getItemsAsync(start, count) | Retrieve, arranged in a by-folder grouping, a number of |
| | files and folders specified by count and beginning at an |
| | index specified by start. |

Table IX illustrates APIs for a query creation namespace, which is a set of interfaces allowing queries to be created by isolated applications. Once created, these queries can be maintained by the broker module and subsequently accessed by the isolated application creating the query. The common preamble for the query creation namespace is “Windows.Storage.StorageFolder”.

TABLE IX

| Name | Description |
|---|---|
| createFileQuery( ) | Creates a query with files arranged in a by-folder |
| | grouping. |
| createFileQuery(CommonFileQuery) | Creates a file-only query using the passed common file |
| | query options. |
| createFileQueryWithOptions(QueryOptions) | Creates a file-only query with query options specified |
| | by the isolated application. |
| createFolderQuery( ) | Creates a query with folders arranged in a by-folder |
| | grouping. |
| createFolderQuery(CommonFolderQuery) | Creates a folder-only query using the passed common |
| | folder query options. |
| createFolderQueryWithOptions(QueryOptions) | Creates a folder-only query with query options |
| | specified by the isolated application. |
| createItemQuery( ) | Creates a query with files and folders arranged in a by- |
| | folder grouping. |
| createItemQueryWithOptions(QueryOptions) | Creates a file and folder query with query options |
| | specified by the isolated application |

Table X illustrates APIs for a storage item persistence namespace, which is a set of interfaces allowing isolated applications to persist storage item objects. Storage item objects can be persisted across multiple executions of an isolated application, as discussed above. The common preamble for the storage item persistence namespace is “StorageApplicationPermissions.futureAccessList”.

TABLE X

| Name | Description |
|---|---|
| add(storageItem, metadata) | Adds the specified storage item object to the |
| | persisted access list, and returns a token to |
| | the isolated application allowing the |
| | persisted storage item object to be |
| | subsequently retrieved. The isolated |
| | application can optionally specify, as |
| | metadata, metadata to be linked to the |
| | persisted storage item object. |
| addOrReplace(token, | Adds the specified storage item object to the |
| storageItem) | persisted access list as with add( ), but also |
| | provides the ability to replace any existing |
| | persisted access list entry corresponding to |
| | the token. The isolated application can |
| | optionally specify, as metadata, metadata to |
| | be linked to the persisted storage item object. |
| getItemAsync(token) | Get the persisted storage item object |
| | specified by the token from the persisted |
| | access list. |
| getFileAsync(token) | Get the persisted StorageFile storage item |
| | object specified by the token from the |
| | persisted access list. |
| getFolderAsync(token) | Get the persisted StorageFolder storage |
| | item object specified by the token from the |
| | persisted access list. |
| remove(token) | Remove the persisted storage item object |
| | specified by the token from the persisted |
| | access list. |
| containsItem(token) | Check, and return an indication of, whether |
| | the storage item object specified by the token |
| | is present in the persisted access list. |
| clear( ) | Clears the access list, removing all persisted |
| | storage item objects from the persisted |
| | access list. |
| checkAccess(storageItem) | Check, and return an indication of, whether |
| | the isolated application has access to the |
| | specified storage item object (e.g., through |
| | a capability or because the item or parent is |
| | persisted). |
| entries | Retrieves the entire set of persisted storage |
| | item objects in the persisted access list. |
| maximumItemsAllowed | Retrieves the maximum number of storage |
| | item objects that are permitted to be persisted |
| | in the persisted access list. |

Table XI illustrates APIs for a most recently used (MRU) list, which is a set of interfaces allowing isolated applications to generated and maintain a list of most recently used items. The MRU list is an example of persisted storage item objects, with the persisted access list being the MRU list. The common preamble for the MRU list namespace is “StorageApplicationPermissions.mostRecentlyUsedList”.

TABLE XI

| Name | Description |
|---|---|
| add(storageItem, metadata) | Adds the specified storage item object to |
| | the MRU list, and returns a token to the |
| | isolated application allowing the persisted |
| | storage item object to be subsequently |
| | retrieved. The isolated application can |
| | optionally specify, as metadata, metadata |
| | to be linked to the persisted storage item |
| | object. |
| addOrReplace(token, | Adds the specified storage item object to |
| storageItem) | the MRU list as with add( ), but also |
| | provides the ability to replace any existing |
| | MRU list entry corresponding to the token. |
| | The isolated application can optionally |
| | specify, as metadata, metadata to be linked |
| | to the persisted storage item object. |
| getItemAsync(token) | Get the persisted storage item object |
| | specified by the token from the MRU list. |
| getFileAsync(token) | Get the persisted StorageFile storage item |
| | object specified by the token from the MRU |
| | list. |
| getFolderAsync(token) | Get the persisted StorageFolder storage item |
| | object specified by the token from the MRU |
| | list. |
| remove(token) | Remove the persisted storage item object |
| | specified by the token from the MRU list. |
| containsItem(token) | Check, and return an indication of, whether |
| | the storage item object specified by the |
| | token is present in the MRU list. |
| clear( ) | Clears the MRU list, removing all persisted |
| | storage item objects from the MRU list. |
| checkAccess(storageItem) | Check, and return an indication of, whether |
| | the isolated application has access to the |
| | specified storage item object (e.g., through a |
| | capability or because the item or parent is |
| | persisted). |
| entries | Retrieves the entire set of persisted storage |
| | item objects in the MRU list. |
| maximumItemsAllowed | Retrieves the maximum number of storage |
| | item objects that are permitted to be persisted |
| | in the MRU list. |

Example Procedures

The following discussion describes brokered item access for isolated applications techniques that may be implemented using the previously described systems and devices. Aspects of each of the procedures may be implemented in hardware, firmware, software, or a combination thereof. The procedures are shown as a set of acts that specify operations performed by one or more devices and are not necessarily limited to the orders shown for performing the operations by the respective acts. In portions of the following discussion, reference will be made to elements of FIGS. 1, 2, and 3.

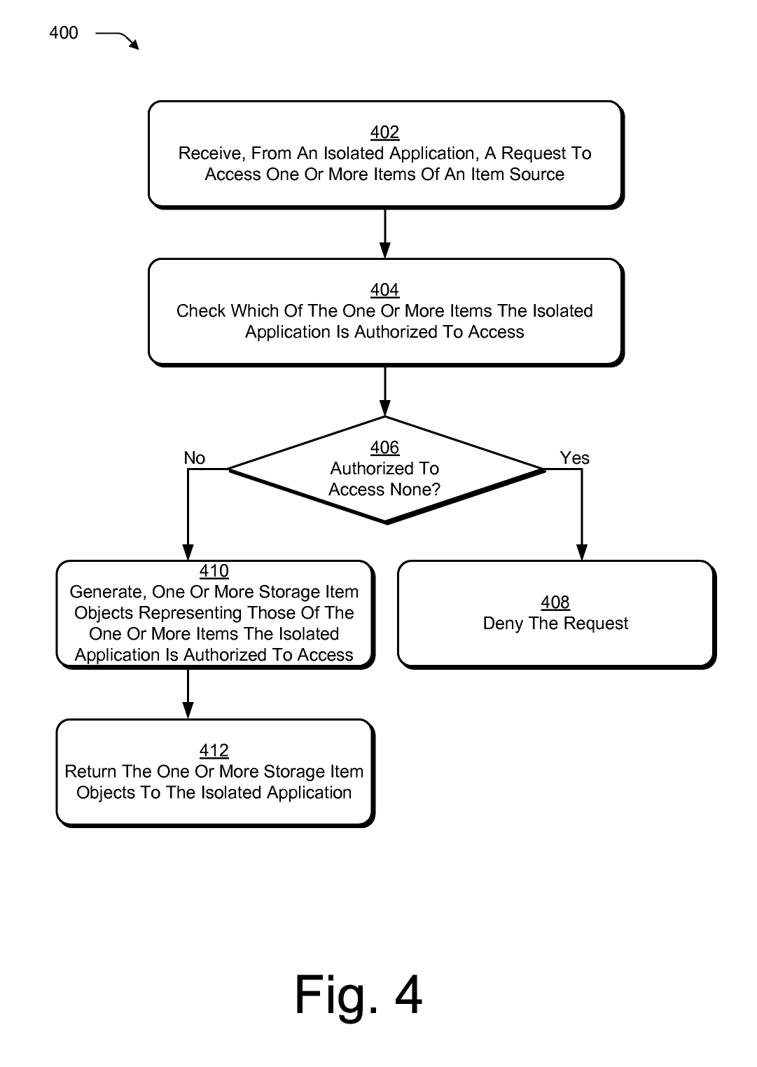

FIG. 4 illustrates a procedure 400 for implementing the brokered item access for isolated applications in accordance with one or more embodiments. Procedure 400 is implemented by a broker module, such as broker module 120. In procedure 400, a request to access one or more items of an item source is received (act 402). The request is received from an isolated application in a computing device, and is typically a request for a particular type of access for a particular item source. The request can be received by the isolated application invoking an API exposed by the broker module, as discussed above. Various different types of requests can be received as discussed above, such as requests to read an item, write an item, modify an item, search for items, and so forth.

A check is made as to which of the one or more items, if any, the isolated application is authorized to access (act 404). Which of one or more items the isolated application is authorized to access can be based on particular item sources and/or particular item locations as discussed above. The check can be made at different times, such as when a root node of an item source (e.g., a folder, a library, a storage structure) is accessed.

Procedure 400 proceeds based on whether the isolation application is authorized to access none of the one or more items (act 406). If the isolated application is authorized to access none of the one or more items (the application is not authorized to access any of the items for which access is requested), then the request is denied (act 408). An indication that the request is denied can optionally be returned to the isolated application as discussed above.

However, if the isolated application is authorized to access at least one of the one or more items, one or more storage item objects that represent those of the one or more items that the isolated application is authorized to access are generated (act 410). Each storage item object includes various information associated with the one or more storage items as discussed above. Those of the one or more items that the isolated application is authorized to access can exclude particular items from the item source that are filtered out, as discussed above.

The one or more generated storage item objects are returned to the isolated application (act 412). The storage item objects can be data structures provided to the isolated application, or objects exposed to the isolated application as discussed above. The storage item objects can optionally be arranged in a particular order or particular grouping, as discussed above.

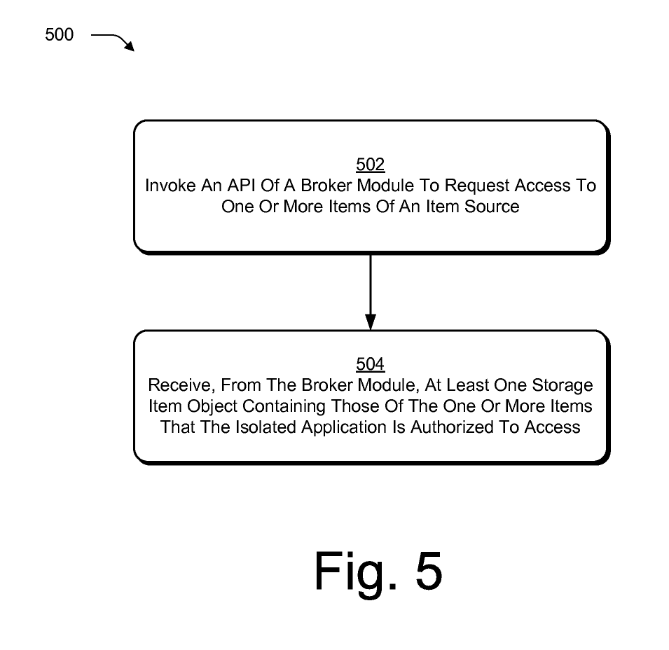

FIG. 5 illustrates a procedure 500 for implementing the brokered item access for isolated applications in accordance with one or more embodiments. Procedure 500 is implemented by an isolated application, such as application 116 or application 202. In procedure 500, an API of a broker module is invoked to request access to one or more items of an item source (act 502). The request is typically a request for a particular type of access for a particular item source. Various different types of requests can be received as discussed above, such as requests to read an item, write an item, modify an item, search for items, and so forth.

At least one storage item object containing those of the one or more items that the isolated application is authorized to access is received from the broker module (act 504). A check as to which of the one or more items the isolated application is authorized to access can be made at different times, such as when a root node of an item source (e.g., a folder, a library, a storage structure) is accessed. Each storage item object includes various information associated with the item as discussed above. Those of the one or more items for which storage item objects are received can exclude particular items from the item source that are filtered out, as discussed above. The storage item objects can be data structures returned to the isolated application, or objects exposed to the isolated application as discussed above. Additionally, the storage item objects can optionally be arranged in a particular order, as discussed above.

### CONCLUSION

Various actions such as communicating, receiving, sending, storing, generating, obtaining, and so forth performed by various modules are discussed herein. It should be noted that the various modules can cause such actions to be performed. A particular module causing an action to be performed includes that particular module itself performing the action, or alternatively that particular module invoking or otherwise accessing another component or module that performs the action (or performs the action in conjunction with that particular module).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method in a computing device, the method comprising:
receiving, at a broker module of the computing device, a request from an isolated application in the computing device to access one or more items of an item source;
checking, in the computing device, which of the one or more items the isolated application is authorized to access; and
if the isolated application is authorized to access none of the one or more items, then denying the request, and otherwise:
generating one or more storage item objects that represent those of the one or more items that the isolated application is authorized to access, and
returning the one or more storage item objects to the isolated application; and

2. A method as recited in claim 1, the isolated application being restricted from accessing the item source other than through the broker module.

3. A method as recited in claim 1, the returning the one or more storage item objects to the isolated application comprising exposing an interface to the isolated application, the interface allowing one or more properties of an item represented by a storage item object to be retrieved, and supporting one or more operations on the item represented by the storage item object.

4. A method as recited in claim 1, the item source comprising a file system of the computing device.

5. A method as recited in claim 1, further comprising persisting, in response to a request from the isolated application, a particular one of the one or more storage item objects.

6. A method as recited in claim 1, the checking comprising checking whether the isolated application is authorized to access items from a particular location of the item source.

7. A method as recited in claim 6, the item source comprising a file system, and the particular location comprising a library of the file system.

8. A method as recited in claim 1, further comprising, filtering those of the one or more items that the isolated application is authorized to access to exclude particular types of items.

9. A method as recited in claim 1, further comprising, arranging those of the one or more items that the isolated application is authorized to access in a particular order, the particular order being identified by the request.

10. A method as recited in claim 1, further comprising, arranging those of the one or more items that the isolated application is authorized to access in a particular grouping, the particular grouping being identified by the request.

11. A method as recited in claim 1, further comprising receiving a user indication, when the isolated application is installed on the computing device, which items the isolated application is authorized to access.

12. A method as recited in claim 1, the request including search criteria, the one or more items comprising one or more items that satisfy the search criteria.

13. One or more computer storage media having stored thereon multiple instructions of an application that, when executed by one or more processors of a computing device, cause the one or more processors to:
invoke an application programming interface (API) of a broker module to request access to one or more items of an item source, the application comprising an isolated application that is being executed by the one or more processors and that is restricted from accessing the item source other than through the broker module; and
receive, from the broker module, at least one storage item object containing those of the one or more items that the isolated application is authorized to access.

14. One or more computer storage media as recited in claim 13, the multiple instructions further causing the one or more processors to persist the at least one storage item object across multiple executions of the application.

15. One or more computer storage media as recited in claim 14, the multiple instructions causing the one or more processor persist the at least one storage item object comprising instructions invoking an API of the broker module to persist the at least one storage item.

16. One or more computer storage media as recited in claim 13, the multiple instructions causing the one or more processors to invoke an API of the broker module comprising instructions causing the one or more processors to invoke an API of the broker module to search items of an item source based on search criteria provided to the broker module by the application.

17. One or more computer storage media as recited in claim 13, the item source comprising a file system of the computing device.

18. One or more computer storage media as recited in claim 13, the item source comprising a storage system of a service provider access over a network.

19. One or more computer storage media as recited in claim 13, the item source comprising another application running on the computing device.

20. A method in a computing device, the method comprising:
receiving, at a broker module of the computing device, a request from an isolated application in the computing device to access one or more files stored in a particular library of a file system of the computing device, the isolated application being restricted from accessing the file system other than through the broker module;
checking, in the computing device based on user input received when the isolated application was downloaded or installed on the computing device, which of the one or more files the isolated application is authorized to access; and
if the isolated application is authorized to access none of the one or more files, then denying the request, otherwise:
generating one or more storage item objects representing those of the one or more files that the isolated application is authorized to access, and
returning the one or more storage item objects to the isolated application.
